(19) United States
(12) Patent Application Publication
(10) Pub. No.: US 2024/0199115 A1
(43) Pub. Date: Jun. 20, 2024

(54) Garden Tool And Method For Control Garden Tool

(71) Applicant: Greenworks (Jiangsu) Co., Ltd., Changzhou (CN)

(72) Inventors: Chaoqun WANG, Changzhou (CN); Qunli WEI, Changzhou (CN); Wenwei XU, Changzhou (CN); Jun FAN, Changzhou (CN); Peng ZHAO, Changzhou (CN); Jiafu XUE, Changzhou (CN)

(73) Assignee: Greenworks (Jiangsu) Co., Ltd., Changzhou (CN)

(21) Appl. No.: 18/534,694

(22) Filed: Dec. 10, 2023

(30) Foreign Application Priority Data
Dec. 20, 2022 (CN) 202211641704.8
Dec. 20, 2022 (CN) 202223423687.9

(51) Int. Cl. B62D 6/00; A01D 34/82; B62D 9/00; B62D 15/02

(52) U.S. Cl. CPC B62D 6/001; A01D 34/824; B62D 9/00; B62D 15/022; A01D 34/64

(57) ABSTRACT

A garden tool and control method thereof is provided. The garden tool includes a steering wheel; a first angle sensor, to which the steering wheel is connected through transmission via a deceleration transmission mechanism; and a control module, to which the first angle sensor is electrically connected, the control module being respectively electrically connected to driving elements of the two driving wheels. The present disclosure utilizes at least one angle sensor in the vehicle control system to generate an actual position signal indicating the position status of the steering wheel, rather than an inferred or expected position of the steering wheel, thus effectively improving response speed and response accuracy.

### TECHNICAL FIELD

The present disclosure belongs to the field of garden tools, specifically to a garden tool and control method thereof.

### BACKGROUND

In order to ensure the flexibility of movement, garden tools such as mowers and snow throwers generally require the ability to achieve small radius steering operations, or even zero radius steering operations. In the related art, steering operations are generally achieved by controlling the deflection angle of the front wheels. With such a steering structure, when achieving zero radius steering, the transmission mechanism is relatively complex, and there is relative sliding friction between the rear wheels and the ground during the steering process, which may cause damage to the lawn.

### SUMMARY

In view of the drawbacks of the related art mentioned above, the present disclosure aims to provide a garden tool and control method thereof that can flexibly control the steering radius and has a simple structure.

To achieve the above and other related purposes, the present disclosure provides a garden tool, including:
a chassis, which is installed with a universal wheel and at least two driving wheels, one of the universal wheel and the driving wheel being located at a front portion of the chassis and the other at a rear portion of the chassis;
a steering wheel, which is rotatably connected to the chassis;
a first angle sensor, to which the steering wheel is connected through transmission via a deceleration transmission mechanism; and
a control module, to which the first angle sensor is electrically connected, and the control module being respectively electrically connected to driving elements of the two driving wheels, wherein
the control module is configured to:
control the two driving wheels to rotate at equal speeds when a rotational angle of the first angle sensor is within a first preset interval,
control the two driving wheels to rotate at different speeds in a same direction when the rotational angle of the first angle sensor is within a second preset interval, and
control the two driving wheels to rotate in reverse directions when the rotational angle of the first angle sensor is within a third preset interval,
wherein, the second preset interval is distributed at two ends of the first preset interval, and the third preset interval is distributed at two ends of a union of the first preset interval and the second preset interval.

In an optional embodiment of the present disclosure, the deceleration transmission mechanism includes:
a first transmission shaft, which is fixedly connected to the steering wheel and rotatably connected to a steering wheel bracket provided on the garden tool;
a second transmission shaft, which is rotatably connected to the chassis of the garden tool, wherein a first end of the second transmission shaft is connected to the first transmission shaft via a universal joint in a synchronously rotating manner, and a second end of the second transmission shaft is provided with a first gear;
a second gear, which is rotatably connected to the chassis of the garden tool and is meshed with the first gear, a diameter of the second gear being greater than that of the first gear; and
a swing arm, a first end of the swing arm being connected to the first angle sensor, and a second end of the swing arm being connected to the second gear.

In an optional embodiment of the present disclosure, the second preset interval includes a first sub interval and a second sub interval provided at two ends of the first preset interval, respectively;
when the rotational angle of the first angle sensor is within the first sub interval, the control module controls a rotational speed of the driving wheel on a left side to be lower than that of the driving wheel on a right side; and
when the rotational angle of the first angle sensor is within the second sub interval, the control module controls the rotational speed of the driving wheel on the right side to be lower than that of the driving wheel on the left side.

In an optional embodiment of the present disclosure, the third preset interval includes a third sub interval and a fourth sub interval, the third sub interval and the fourth sub interval are provided at two ends of the union of the first preset interval and the second preset interval, respectively;
when the rotational angle of the first angle sensor is within the third sub interval, the control module controls the driving wheel on the left side to rotate in an opposite direction; and
when the rotational angle of the first angle sensor is within the fourth sub interval, the control module controls the driving wheel on the right side to rotate in an opposite direction.

In an optional embodiment of the present disclosure, the first preset interval is [−1°, +1°].

In an optional embodiment of the present disclosure, the second preset interval is [−11°,−1°)∪(+1°,+11°], wherein the first sub interval is [−11°, −1°), and the second sub interval is (+1°, +11°].

In an optional embodiment of the present disclosure, the third preset interval is [−21°,−11°)∪(+11°,+21°], wherein the third sub interval is [−21°, −11°), and the fourth sub interval is (+11°, +21°].

In an optional embodiment of the present disclosure, the garden tool further includes a control device, the control device including:
an accelerator pedal; and
a second angle sensor, wherein the accelerator pedal is connected to the second angle sensor through transmission via a linkage mechanism, and the second angle sensor is electrically connected to the control module, and
wherein the control module is configured to control a rotational speed of the driving wheel to increase when a rotational angle of the second angle sensor increases.

In an optional embodiment of the present disclosure, when the rotational angle of the first angle sensor is within the first preset interval, the rotational speed N_{L} of the driving wheel on the left side and the rotational speed N_{R} of the driving wheel on the right side meet the following requirements:

N_{L}=N_{R}=(Nₘₐₓ/(Uₘₐₓ−Uₘᵢₙ))*(U₂−Uₘᵢₙ);
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, and U₂ represents a real-time output voltage of the second angle sensor; and
wherein an output voltage of the second angle sensor increases with an increase of the rotational angle of the second angle sensor.

In an optional embodiment of the present disclosure, when the rotational angle of the first angle sensor is within the first sub interval, the rotational speed N_{L} of the driving wheel on the left side and the rotational speed N_{R} of the driving wheel on the right side meet the following requirements:

N_{R}=(Nₘₐₓ/(Uₘₐₓ−Uₘᵢₙ))*(U₂−Uₘᵢₙ);

N_{L}=((U₁−Uₐ)/(U_{b}−Uₐ))*N_{R};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, Uₐ and U_{b} respectively represent a minimum output voltage and a maximum output voltage of the first angle sensor when the rotational angle of the first angle sensor is within the first sub interval, and U₁ represents a real-time output voltage of the first angle sensor; and
wherein the real-time output voltage U₁ of the first angle sensor increases with an increase of the rotational angle of the first angle sensor, and the real-time output voltage U₂ of the second angle sensor increases with an increase of the rotational angle of the second angle sensor.

In an optional embodiment of the present disclosure, when the rotational angle of the first angle sensor is within the second sub interval, the rotational speed N_{L} of the driving wheel on the left side and the rotational speed N_{R} of the driving wheel on the right side meet the following requirements:

N_{L}=(Nₘₐₓ/(Uₘₐₓ−Uₘᵢₙ))*(U₂−Uₘᵢₙ);

N_{R}=((U_{d}−U₁)/(U_{d}−U_{c}))*N_{L};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, U_{c} and U_{d} respectively represent a minimum output voltage and a maximum output voltage of the first angle sensor when the rotational angle of the first angle sensor is within the second sub interval, and U₁ represents a real-time output voltage of the first angle sensor; and
wherein the real-time output voltage U₁ of the first angle sensor increases with the increase of the rotational angle of the first angle sensor, and the real-time output voltage U₂ of the second angle sensor increases with the increase of the rotational angle of the second angle sensor.

In an optional embodiment of the present disclosure, when the rotational angle of the first angle sensor is within the third sub interval, the rotational speed N_{L} of the driving wheel on the left side and the rotational speed N_{R} of the driving wheel on the right side meet the following requirements:

N_{R}=(Nₘₐₓ/(Uₘₐₓ−Uₘᵢₙ))*(U₂−Uₘᵢₙ);

N_{L}=−((U_{f}−U₁)/(U_{f}−Uₑ))*N_{R};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, Uₑ and U_{f} respectively represent a minimum output voltage and a maximum output voltage of the first angle sensor when the rotational angle of the first angle sensor is within the third sub interval, and U₁ represents a real-time output voltage of the first angle sensor; and
wherein the real-time output voltage U₁ of the first angle sensor increases with an increase of the rotational angle of the first angle sensor, and the real-time output voltage U₂ of the second angle sensor increases with an increase of the rotational angle of the second angle sensor.

In an optional embodiment of the present disclosure, when the rotational angle of the first angle sensor is within the fourth sub interval, the rotational speed N_{L} of the driving wheel on the left side and the rotational speed N_{R} of the driving wheel on the right side meet the following requirements:

N_{L}=(Nₘₐₓ/(Uₘₐₓ−Uₘᵢₙ))*(U₂−Uₘᵢₙ);

N_{R}=−((U₁−U_{g})/(Uₕ−U_{g}))*N_{L};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, U_{g} and Uₕ respectively represent a minimum output voltage and a maximum output voltage of the first angle sensor when the rotational angle of the first angle sensor is within the fourth sub interval, and U₁ represents a real-time output voltage of the first angle sensor; and
wherein the real-time output voltage U₁ of the first angle sensor increases with an increase of the rotational angle of the first angle sensor, and the real-time output voltage U₂ of the second angle sensor increases with an increase of the rotational angle of the second angle sensor.

To achieve the above and other related purposes, the present disclosure further provides a method for control a garden tool, wherein, the garden tool includes a first angle sensor configured to identify a rotation of a steering wheel, the first angle sensor being electrically connected to a control module, the control module being respectively electrically connected to a left driving wheel and a right driving wheel, the method includes the following steps:
obtaining a detection signal of the first angle sensor;
controlling rotational speeds of the left driving wheel and the right driving wheel according to the detection signal, including:
   controlling the left driving wheel and the right driving wheel to rotate at equal speeds when a left or right rotational angle of the steering wheel is less than or equal to a first preset value;
   controlling the rotational speed of the left driving wheel to be lower than that of the right driving wheel when the steering wheel is turning to the left and the rotational angle is larger than the first preset value and less than or equal to a second preset value;
   controlling the left driving wheel to rotate backwards when the steering wheel is turning to the left and the rotational angle is larger than the second preset value;
   controlling the rotational speed of the right driving wheel to be lower than that of the left driving wheel when the steering wheel is turning to the right and the rotational angle is larger than the first preset value and less than or equal to the second preset value; and
controlling the right driving wheel to rotate backwards when the steering wheel is turning to the right and the rotational angle is larger than the second preset value.

In an optional embodiment of the present disclosure, when a left or right rotational angle of the steering wheel is less than or equal to the first preset value, the left driving wheel and the right driving wheel rotate at equal speeds in a same direction;
when the left or right rotational angle of the steering wheel is larger than the first preset value and less than or equal to the second preset value, the left driving wheel and the right driving wheel rotate at different speeds in the same direction; and
when the left or right rotational angle of the steering wheel is larger than the second preset value, the left driving wheel and the right driving wheel rotate at equal speeds in reverse directions.

In an optional embodiment of the present disclosure, when a left or right rotational angle of the steering wheel is less than or equal to the first preset value, a rotational angle of the first angle sensor is within a first preset interval;
when the left or right rotational angle of the steering wheel is larger than the first preset value and less than or equal to the second preset value, the rotational angle of the first angle sensor is within a second preset interval; and
when the left or right rotational angle of the steering wheel is larger than the second preset value, the rotational angle of the first angle sensor is within a third preset interval.

In an optional embodiment of the present disclosure, the first preset interval is [−1°, +1°].

In an optional embodiment of the present disclosure, the second preset interval is [−11°,−1°)∪(+1°,+11°].

In an optional embodiment of the present disclosure, the third preset interval is [−21°,−11°)∪(+11°,+21°].

In an optional embodiment of the present disclosure, the garden tool further includes:
an accelerator pedal; and
a second angle sensor, wherein the accelerator pedal is connected to the second angle sensor through transmission via a linkage mechanism, and the second angle sensor is electrically connected to the control module, and
wherein the control module is configured to control a rotational speed of the left driving wheel and the right driving wheel to increase when a rotational angle of the second angle sensor increases.

To achieve the above and other related purposes, the present disclosure provides a garden tool, which including:
a chassis, which is installed with at least one universal wheel and two driving wheels, one of the universal wheel and the driving wheel being located at a front portion of the chassis and the other at a rear portion of the chassis, the two driving wheels being disposed on the left and right sides of the chassis, respectively;
a steering wheel, which is rotatably connected to the chassis;
a first angle sensor, to which the steering wheel is connected through transmission via a deceleration transmission mechanism;
a control module, to which the first angle sensor is electrically connected, and the control module being electrically connected to driving elements of the two driving wheels, respectively,
wherein the control module is configured to be capable of controlling speeds and directions of rotation of the two driving wheels based on a rotational angle of the first angle sensor, respectively, in order to achieve straight and steering operations of the garden tool.

In an optional embodiment of the present disclosure, the deceleration transmission mechanism includes:
a first transmission shaft, which is fixedly connected to the steering wheel and rotatably connected to a steering wheel bracket provided on the garden tool;
a second transmission shaft, which is rotatably connected to the chassis of the garden tool, wherein a first end of the second transmission shaft is connected to the first transmission shaft via a universal joint in a synchronously rotating manner, and a second end of the second transmission shaft is provided with a first gear;
a second gear, which is rotatably connected to the chassis of the garden tool and is meshed with the first gear, a diameter of the second gear being greater than that of the first gear; and
a swing arm, a first end of the swing arm being connected to the first angle sensor, and a second end of the swing arm being connected to the second gear.

In an optional embodiment of the present disclosure, the second gear is a sector gear, a sector center of the second gear is provided with a rotating shaft, the rotating shaft is rotatably connected to the chassis, a sector surface of the second gear is provided with an arc-shaped hole, an arc center of the arc-shaped hole coincides with the sector center, the chassis is provided with a guide pin, the guide pin is inserted into the arc hole and forms a sliding fit with the arc hole.

In an optional embodiment of the present disclosure, a rotation center of the swing arm is coaxial with the sector center of the second gear.

In an optional embodiment of the present disclosure, the first rotating shaft is inclinedly provided, the second transmission shaft is vertically provided, and the second gear is installed under the chassis.

In an optional embodiment of the present disclosure, the control device further includes:
an accelerator pedal; and
a second angle sensor, wherein the accelerator pedal is connected to the second angle sensor through transmission via a linkage mechanism, and the second angle sensor is electrically connected to the control module, and
wherein the control module is configured to control a rotational speed of the driving wheel to increase when a rotational angle of the second angle sensor increases.

In an optional embodiment of the present disclosure, the accelerator pedal is fixedly connected to a horizontal rotating shaft, the horizontal rotating shaft is rotatably connected to the chassis, the linkage mechanism includes a first swing rod, a link rod, and a second swing rod, the first swing rod is fixedly connected to the horizontal rotating shaft, the second swing rod is connected to the second angle sensor, and the two ends of the link rod are respectively hinged with the first swing rod and the second swing rod.

In an optional embodiment of the present disclosure, wherein, the horizontal rotating shaft is provided with a cantilever, a damper is provided between the cantilever and the chassis, two ends of the damper are respectively hinged with the cantilever and the chassis.

In an optional embodiment of the present disclosure, the chassis is provided with an installation seat, and the second angle sensor and the damper are installed on the installation seat.

To achieve the above and other related purposes, the present disclosure further provides a mower, which includes:
a chassis, under which a cutter assembly is provided;
a universal wheel, which is installed at a front end of the chassis;
driving wheels, the number of which is set to two, and the two driving wheels being provided at left and right sides of the chassis, respectively;
a steering wheel, which is rotatably provided above the chassis;
a first angle sensor, which is connected to the steering wheel through transmission, to identify a rotation of the steering wheel; and
a control module, which is connected to a detection signal output terminal of the first angle sensor, and the control module being connected to a control signal input terminal of the driving wheel;
the control module is configured to be capable of controlling speeds and directions of rotation of the two driving wheels based on a rotational angle of the first angle sensor, respectively, in order to achieve straight and steering operations of the garden tool.

The technical effects of the present disclosure lie in: the present disclosure utilizes at least one angle sensor in the vehicle control system to generate an actual position signal indicating the position status of the steering wheel, rather than an inferred or expected position of the steering wheel, thus effectively improving response speed and response accuracy; the present disclosure utilizes a steering input device (such as a steering wheel) to input the operator's operating intention, and detects the actual position of the steering input device through an angle sensor to generate a signal, this signal is processed by a control module to control one or more drivable structures of the vehicle, enabling the driving motor to achieve forward and reverse rotation of the left and right wheels via a gearbox, when steering, the universal wheel change the turning angle with the control of the rotational speeds and steering for the left and right rear wheels; the present disclosure avoids the problem of excessive sensitivity of sensor potential changes caused by slight rotation of the steering wheel and some idle stroke on the transmission structure through deceleration transmission, ensuring smooth and stable machine operation during zero steering.

### BRIEF DESCRIPTION OF DRAWINGS

FIG. 1 is a perspective view of the mower provided by an embodiment of the present disclosure;

FIG. 2 is a top view of the mower provided by an embodiment of the present disclosure;

FIG. 3 is a transmission structure diagram of the control device provided in an embodiment of the present disclosure;

FIG. 4 is a perspective view of the deceleration transmission mechanism provided by an embodiment of the present disclosure;

FIG. 5 is a perspective view of the linkage transmission mechanism provided in the embodiment of the present disclosure;

FIG. 6 is a control schematic diagram of the mower provided in an embodiment of the present disclosure in a straight ahead state;

FIG. 7 is a control schematic diagram of the mower provided in an embodiment of the present disclosure in a left normal steering state;

FIG. 8 is a control schematic diagram of the mower provided in an embodiment of the present disclosure in a left zero radius steering state;

FIG. 9 is a flowchart of the steering control method for the mower provided in an embodiment of the present disclosure;

FIG. 10 is a schematic diagram of the mower provided in an embodiment of the present disclosure when steering normally;

FIG. 11 is a schematic diagram of the mower provided in an embodiment of the present disclosure when zero radius steering;

FIG. 12 is a curve of the voltage of the angle sensor provided by an embodiment of the present disclosure as a function of the angle;

FIG. 13 is a schematic diagram of the angle sensor provided in an embodiment of the present disclosure divided into intervals; and

FIG. 14 is a schematic diagram of the relationship between voltage and angle provided by an embodiment of the present disclosure.

### DESCRIPTION OF EMBODIMENTS

The following are specific examples to illustrate the embodiments of the present disclosure, and those skilled in the art can easily understand the other advantages and effects of the present disclosure from the content disclosed herein. The present disclosure can also be implemented or applied through different specific embodiments, and the details herein can also be modified or changed based on different perspectives and applications without departing from the present disclosure. It should be noted that, without conflict, the following embodiments and the features in the embodiments can be combined with each other.

It should be noted that the illustrations provided in the following embodiments only illustrate the basic concept of the present disclosure in a schematic manner. Therefore, the illustrations only show the components related to the present disclosure and are not drawn based on the actual number, shape, and size of the components during implementation. The type, quantity, and proportion of each component during actual implementation can be arbitrarily changed, and the component layout may also be more complex.

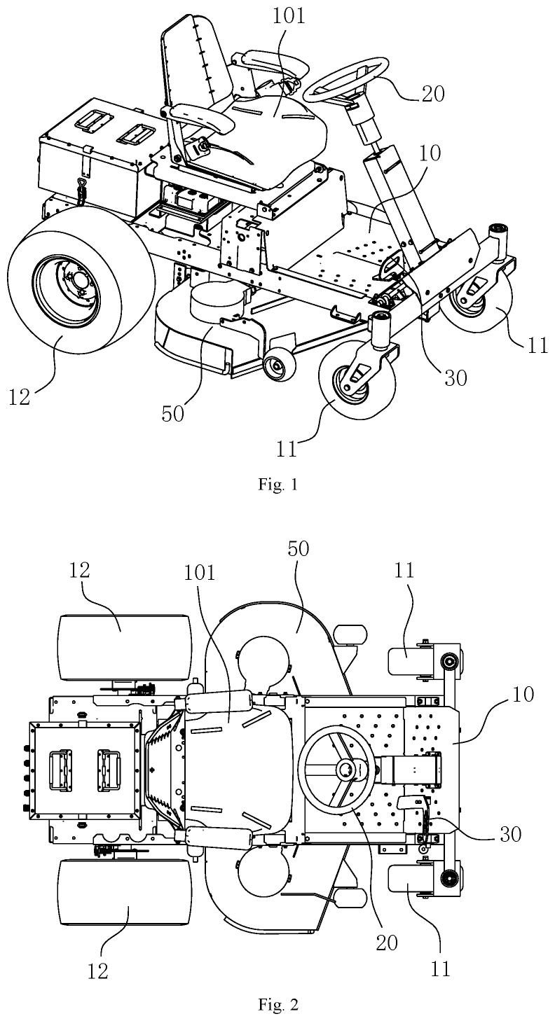

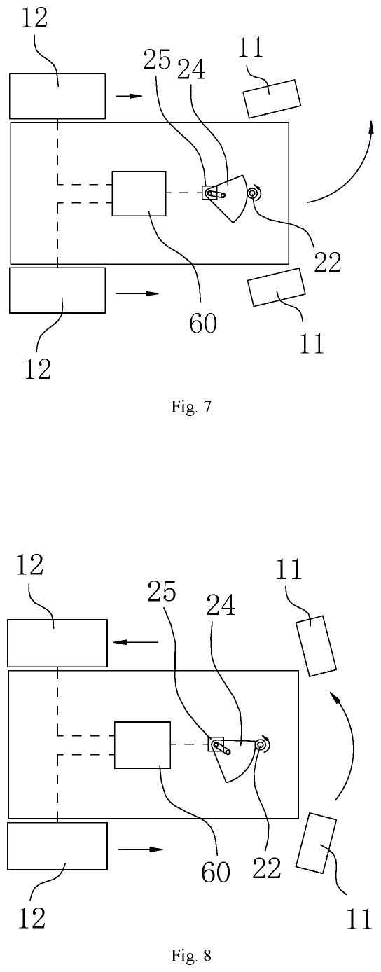

Please refer to FIGS. 1-14 for a detailed explanation of the technical solution of the present disclosure in conjunction with a mower. It can be understood that the control device and the control method thereof provided by the present disclosure are not only applicable to mowers, but also to other garden tools such as snow throwers.

Please refer to FIGS. 1 and 2, a mower includes a chassis 10, universal wheels 11, driving wheels 12, and a control device. Specifically, the universal wheels 11 are installed at the front end of the chassis 10; the driving wheels 12 are provided with two, and the two driving wheels 12 are placed on the left and right sides of the chassis 10. It can be understood that the front and rear position relationship between the universal wheels 11 and the driving wheels 12 is not unique. For example, in some embodiments, the driving wheels 12 can also be provided at the front end of the chassis 10 and the universal wheels 11 can be provided at the rear end of the chassis 10. The number of universal wheels 11 is not unique, for example, in some embodiments, the number of universal wheels 11 may only be one.

It can be understood that the mower also includes a cutter assembly 50. In this embodiment, the cutter assembly 50 is located below the middle of the chassis 10. Similarly, the arrangement of the cutter assembly 50 can be freely selected according to actual needs, for example, the cutter assembly 50 can also be installed at the front or rear end of the chassis 10. In this embodiment, there is also a seat 101 provided on the chassis 10, for the operator to sit. However, it can be understood that the seat 101 is not necessary for the mower, for example, the operator can also operate the mower in a standing posture.

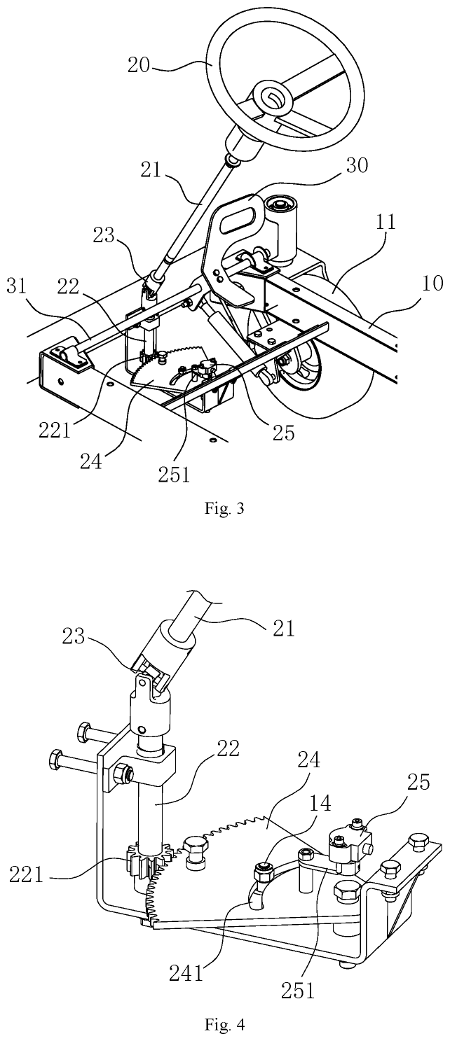

As shown in FIGS. 3-8, the control device includes a steering wheel 20, a first angle sensor 25, and a control module 60.

Please refer to FIGS. 3 and 4, where the steering wheel 20 is rotatably provided above the chassis 10. It can be understood that the steering wheel 20 of the present disclosure does not directly drive the wheel to rotate, but rather serves as an input apparatus that enables the control module 60 to determine the operator's intention based on the rotation of the steering wheel 20.

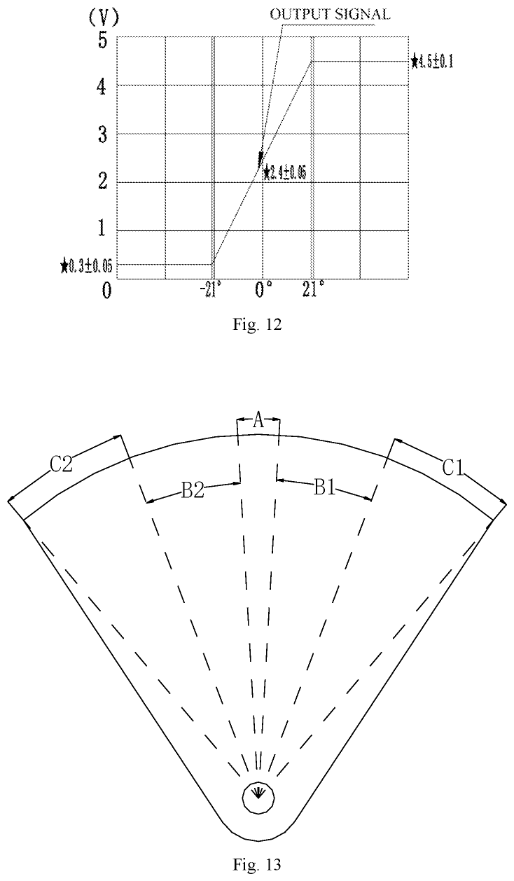

Please refer to FIGS. 3 and 4, where the first angle sensor 25 is connected to the steering wheel 20 through transmission to identify the rotation of the steering wheel 20. The angle sensor of the present disclosure is a device that can convert mechanical motion into new signals. Specifically, it is a device that can output different voltages based on angle changes, and the voltage is linearly related to the angle. As shown in FIG. 12, the control module 60 can determine the rotational angle of the angle sensor based on the voltage change of the angle sensor.

Please refer to FIGS. 6-11, where the control module 60 is connected to a detection signal output terminal of the first angle sensor 25, and the control module 60 is connected to control signal input terminals of the driving wheel 12. The control module 60 is configured to: control the two driving wheels 12 to rotate at equal speeds when the rotational angle of the first angle sensor 25 is within a first preset interval A; control the two driving wheels 12 to rotate at different speeds in the same direction when the rotational angle of the first angle sensor 25 is within a second preset interval B; and control the two driving wheels 12 to rotate in reverse directions when the rotational angle of the first angle sensor 25 is within a third preset interval C; wherein, the second preset interval B is distributed at two ends of the first preset interval A, and the third preset interval C is distributed at two ends of a union of the first preset interval A and the second preset interval B. It can be understood that the steering wheel 20 is connected to the first angle sensor 25 through a deceleration transmission mechanism, and the rotational angle of the first angle sensor 25 will synchronously change in a certain proportion based on the rotational angle of the steering wheel 20. Therefore, the angle change of the first angle sensor 25 can objectively reflect the operator's driving intention. Due to the use of a deceleration transmission mechanism, significant changes in the detection data of the first angle sensor 25 only occur when the steering wheel 20 rotates for a large stroke. This can avoid the first angle sensor 25 being accidentally touched when the steering wheel 20 experiences slight shaking, and on the other hand, it can make the steering angle control smoother and improve control accuracy. In addition, the first angle sensor 25 has a certain idle stroke near the initial position. For example, when the detection angle of the first angle sensor 25 is within ±1°, the control module 60 does not respond in any way to prevent the steering from being too sensitive and exceeding user's expectations, and is also used to reduce deviations between different machines. When the detection angle of the first angle sensor 25 is in this area, the rotational speeds of the left and right wheels are the same, and the directions are determined by the gear switch.

FIGS. 10 and 11 are schematic top views of the vehicle's steering, demonstrating its ability to achieve essentially ideal Ackermann steering. FIG. 10 shows a non-zero radius turning, and FIG. 11 shows a zero radius turning. When the front wheels turn as shown in FIG. 10, they follow two different curved paths A1 and A2, which theoretically have a common center point C. In theory, the rotational speeds of the left and right wheels can be controlled by a controller to achieve differential turning of the left and right wheels, avoiding rubber friction on the tire tread on the wheels or damaging plants under the front wheels.

The present disclosure utilizes at least one angle sensor in a vehicle control system to generate an actual position signal indicating the position status of steering wheel 20, rather than an inferred or expected position of the steering wheel 20, thereby effectively improving response speed and response accuracy. The present disclosure utilizes a steering input device (such as steering wheel 20) to input the operator's operating intention, and detects the actual position of the steering input device through an angle sensor, and generates a signal. This signal is processed by the control module 60 to control one or more driving structures of the vehicle, enabling the driving motor to achieve forward and reverse rotation of the left and right wheels via a gearbox. When steering, the universal wheel 11 changes the turning angle under the rotational speed and steering control for the left and right rear wheels. The present disclosure avoids the problem of excessive sensitivity of sensor potential changes caused by slight rotation of the steering wheel 20 and some idle stroke on the transmission structure through deceleration transmission, ensuring smooth and stable machine operation during zero steering.

Please refer to FIGS. 3 and 4, in an optional embodiment of the present disclosure, the reduction transmission mechanism includes a first transmission shaft 21, a second transmission shaft 22, a second gear 24, and a swing arm 251. Specifically, the first transmission shaft 21 is fixedly connected to the steering wheel 20 and rotatably connected to a bracket of the steering wheel 20 provided on the garden tool; the second transmission shaft 22 is rotatably connected to the chassis 10 of the garden tool, a first end of the second transmission shaft 22 is connected to the first transmission shaft 21 via a universal joint in a synchronously rotating manner, and a second end of the second transmission shaft 22 is provided with a first gear 221; the second gear 24 is rotatably connected to the chassis 10 of the garden tool and is meshed with the first gear 221, the diameter of the second gear 24 is greater than that of the first gear 221; a first end of the swing arm 251 is connected to the first angle sensor 25, and a second end of the swing arm 251 is connected to the second gear 24. Specifically, the first angle sensor 25 includes a body and a detection shaft provided rotatable to the body. The body is provided therein a detection element for identifying the rotational angle of the detection shaft. The swing arm 251 is connected to the detection shaft and can transmit the rotational motion of steering wheel 20 in real-time to the detection shaft, thereby detecting the rotational angle of steering wheel 20. The present disclosure has a simple structure, low manufacturing cost, and simple and convenient installation. Compared to the linkage transmission and the transmission structures such as gears and belt sprockets, the adoption of a universal wheel 11 structure reduces manufacturing difficulty, releases the limitation of the front wheel steering angle, and achieves theoretically infinite close to zero turning radius.

Please refer to FIGS. 3 and 4, in a specific embodiment, the second gear 24 is a sector gear. The sector center of the second gear 24 is provided with a rotating shaft, which is rotatably connected to the chassis 10. The sector surface of the second gear 24 is provided with an arc-shaped hole 241, and the arc center of the arc-shaped hole 241 coincides with the sector center. The chassis 10 is provided with a guide pin 14, which is inserted into the arc hole 241 and forms a sliding fit with the arc hole 241. The rotation center of the swing arm 251 is coaxial with the sector center of the second gear 24. The first rotating shaft is inclinedly provided, the second transmission shaft 22 is vertically provided, and the second gear 24 is installed under the chassis 10. The present disclosure hides most of the transmission components under the chassis 10, simplifying the upper structure of the mower, increasing the riding space, and improving the comfort of the operator.

Please refer to FIGS. 6 and 8, in a specific embodiment, the second preset interval B includes a first sub interval B1 and a second sub interval B2 provided at two ends of the first preset interval A. When the rotational angle of the first angle sensor 25 is within the first sub interval B1, the control module 60 controls the rotational speed of the left driving wheel 12 to be lower than that of the right driving wheel 12. When the rotational angle of the first angle sensor 25 is within the second sub interval B2, the control module 60 controls the rotational speed of the right driving wheel 12 to be lower than that of the left driving wheel 12.

The third preset interval C includes a third sub interval C1 and a fourth sub interval C2, which are provided at two ends of the union of the first preset interval A and the second preset interval B, respectively. When the rotational angle of the first angle sensor 25 is within the third sub interval C1, the control module 60 controls the left driving wheel 12 to rotate in an opposite direction. When the rotational angle of the first angle sensor 25 is within the fourth sub interval C2, the control module 60 controls the right driving wheel 12 to rotate in an opposite direction.

As shown in FIG. 12, when the first angle sensor 25 changes within a certain angle range, the output voltage of the first angle sensor 25 changes with its rotational angle, resulting in an increasing straight line between angle and voltage. The first preset interval A of the present disclosure should be taken from the middle area of the straight line. The second preset interval B should be areas extending from two ends of the first preset interval A, these two areas represent a left normal steering and a right normal steering, respectively. While the third preset interval C should be the two end areas extending outward from the two second preset intervals B, these two areas represent the left zero radius steering and the right zero radius steering, respectively. It can be understood that the position of the 0 point of the angle in FIG. 12 can be considered predetermined. For example, in this embodiment, the midpoint of the inclined line is used as the 0 point, which facilitates determining the direction of turning based on the positive or negative attributes of the angle.

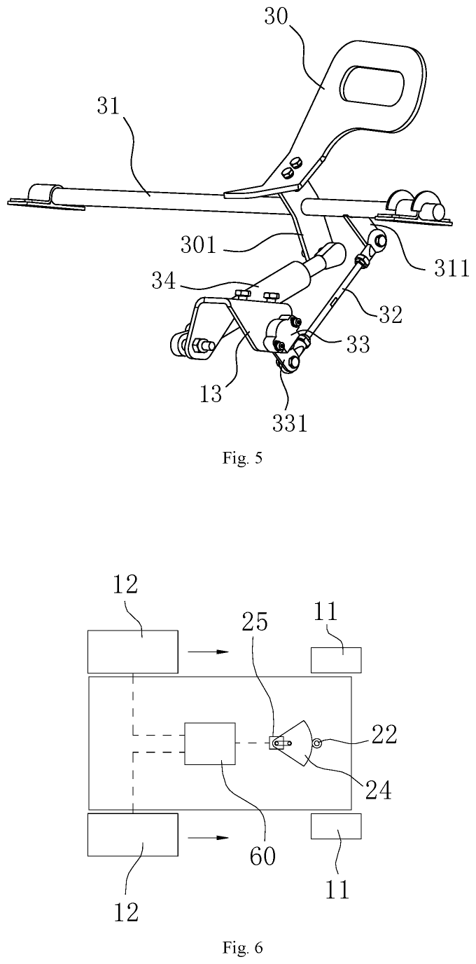

Please refer to FIGS. 3 and 5, in a specific embodiment, the control device further includes an accelerator pedal 30 and a second angle sensor 33. Specifically, the accelerator pedal 30 is connected to the second angle sensor 33 through transmission via a linkage mechanism, and the second angle sensor 33 is electrically connected to the control module 60. The control module 60 is configured to control the rotational speed increase of the driving wheel 12 when the rotational angle of the second angle sensor 33 increases.

Please refer to FIGS. 3 and 5, in a specific embodiment, the accelerator pedal 30 is fixedly connected to a horizontal rotating shaft 31, which is rotatably connected to the chassis 10. The linkage mechanism includes a first swing rod 311, a link rod 32, and a second swing rod 331. The first swing rod 311 is fixedly connected to the horizontal rotating shaft 31, the second swing rod 331 is connected to the second angle sensor 33, and the two ends of the link rod 32 are respectively hinged with the first swing rod 311 and the second swing rod 331. The horizontal rotating shaft 31 is provided with a cantilever 301, and a damper 34 is provided between the cantilever 301 and the chassis 10. The two ends of the damper 34 are respectively hinged with the cantilever 301 and the chassis 10. The chassis 10 is provided with an installation seat 13, and the second angle sensor 33 and the damper 34 are installed on the installation seat 13.

In a specific embodiment, the present disclosure determines the rotational speed of one of the driving wheels 12 by the stepping depth of the accelerator pedal 30, that is, the rotational speed of the outside one of the driving wheels 12 during steering, and then adjusts the rotational speed of the other driving wheel 12 based on the rotational state of the steering wheel 20, with the rotational speed of the outside one as a reference. The specific control method is as follows.

When the rotational angle of the first angle sensor 25 is within the first preset interval A, the rotational speed N_{L} of the left driving wheel 12 and the rotational speed N_{R} of the right driving wheel 12 meet the following requirements:

N_{L}=N_{R}=(Nₘₐₓ/(Uₘₐₓ−Uₘᵢₙ))*(U₂−Uₘᵢₙ).

When the rotational angle of the first angle sensor 25 is within the first sub interval B1, the rotational speed N_{L} of the left driving wheel 12 and the rotational speed N_{R} of the right driving wheel 12 meet the following requirements:

N_{R}=(Nₘₐₓ/(Uₘₐₓ−Uₘᵢₙ))*(U₂−Uₘᵢₙ);

N_{L}=((U₁−Uₐ)/(U_{b}−Uₐ))*N_{R}.

When the rotational angle of the first angle sensor 25 is within the second sub interval B2, the rotational speed N_{L} of the left driving wheel 12 and the rotational speed N_{R} of the right driving wheel 12 meet the following requirements:

N_{L}=(Nₘₐₓ/(Uₘₐₓ−Uₘᵢₙ))*(U₂−Uₘᵢₙ);

N_{R}=((U_{d}−U₁)/(U_{d}−U_{c}))*N_{L}.

When the rotational angle of the first angle sensor 25 is within the third sub interval C1, the rotational speed N_{L} of the left driving wheel 12 and the rotational speed N_{R} of the right driving wheel 12 meet the following requirements:

N_{R}=(Nₘₐₓ/(Uₘₐₓ−Uₘᵢₙ))*(U₂−Uₘᵢₙ);

N_{L}=−((U_{f}−U₁)/(U_{f}−Uₑ))*N_{R}.

When the rotational angle of the first angle sensor 25 is within the fourth sub interval C2, the rotational speed N_{L} of the left driving wheel 12 and the rotational speed N_{R} of the right driving wheel 12 meet the following requirements:

N_{L}=(Nₘₐₓ/(Uₘₐₓ−Uₘᵢₙ))*(U₂−Uₘᵢₙ);

N_{R}=−((U₁−U_{g})/(Uₕ−U_{g}))*N_{L}.

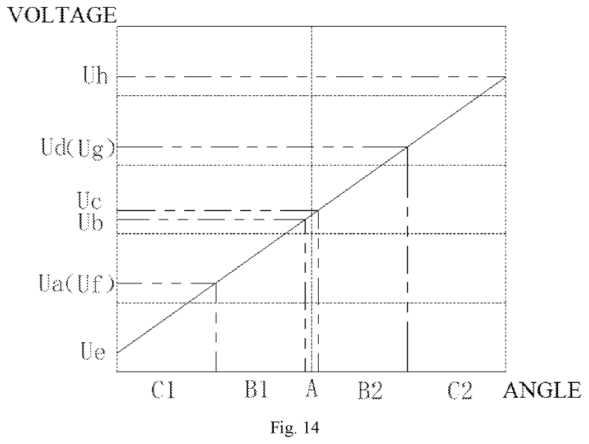

Among them, Nₘₐₓ represents a maximum rotational speed of the driving wheel 12, Uₘₐₓ represents a maximum output voltage of the second angle sensor 33, Uₘᵢₙ represents a minimum output voltage of the second angle sensor 33, and U₂ represents a real-time output voltage of the second angle sensor 33; Uₐ and U_{b} respectively represent a minimum output voltage and a maximum output voltage of the first angle sensor 25 when the rotational angle of the first angle sensor 25 is within the first sub interval B1, and U₁ represents a real-time output voltage of the first angle sensor 25; U_{c} and U_{d} respectively represent a minimum output voltage and a maximum output voltage of the first angle sensor 25 when the rotational angle of the first angle sensor 25 is within the second sub interval B2, while Uₑ and U_{f} respectively represent a minimum output voltage and a maximum output voltage of the first angle sensor 25 when the rotational angle of the first angle sensor 25 is within the third sub interval C1, U_{g} and Uₕ respectively represent a minimum output voltage and a maximum output voltage of the first angle sensor 25 when the rotational angle of the first angle sensor 25 is within the fourth sub interval B2. Please refer to FIGS. 13 and 14, in a specific embodiment, the third sub interval C1, the first sub interval B1, the first preset interval A, the second sub interval B2, and the fourth sub interval C2 are adjacent in this order. Therefore, in this embodiment, Uₐ=U_{f}, and U_{d}=U_{g}.

It should be noted that in the present disclosure, the positive and negative rotational speeds respectively represent the different rotational directions of the driving wheel 12. That is, when the rotational speed is positive, it indicates that the driving wheel 12 rotates forward, while when the rotational speed is negative, it indicates that the driving wheel 12 rotates backward.

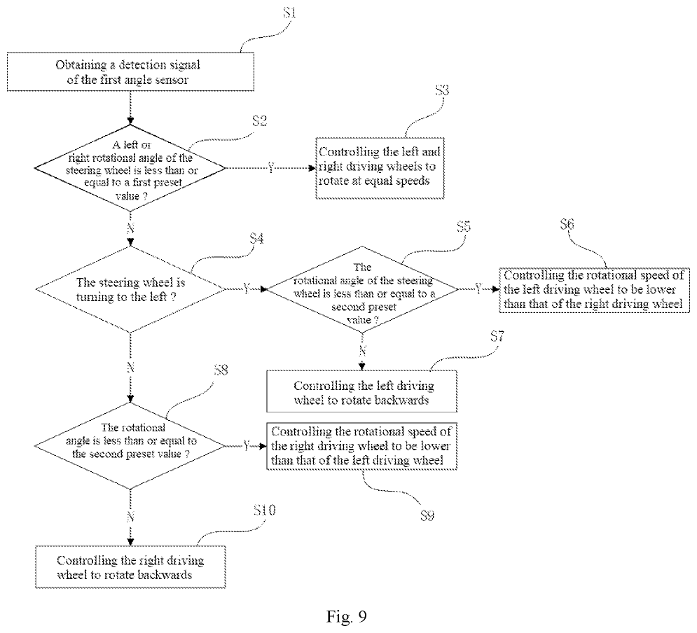

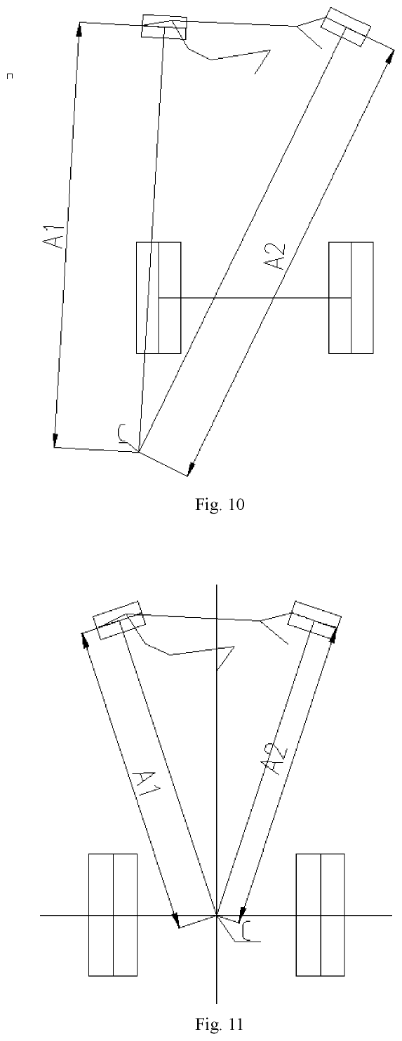

Please refer to FIG. 9, based on the above control device, the present disclosure also provides a control method for a garden tool, the method includes the following steps:
S1: Obtaining a detection signal of the first angle sensor 25;
Controlling the rotational speeds of the left driving wheel 12 and the right driving wheel 12 according to the detection signal, including:
S2: Determining whether a left or right rotational angle of the steering wheel 20 is less than or equal to a first preset value. If so, proceed to S3, otherwise, proceed to S4;
S3: Controlling the left and right driving wheels 12 to rotate at equal speeds;
S4: Determine whether the steering wheel 20 is turning to the left. If so, proceed to S5, otherwise, proceed to S8;
S5: Determining whether the rotational angle of the steering wheel 20 is less than or equal to a second preset value. If so, proceed to S6, otherwise, proceed to S7;
S6: Controlling the rotational speed of the left driving wheel 12 to be lower than that of the right driving wheel 12;
S7: Controlling the left driving wheel 12 to rotate backwards;
S8: Determine whether the rotational angle of steering wheel 20 is less than or equal to the second preset value. If so, proceed to S9, otherwise, proceed to S10;
S9: Controlling the rotational speed of the right driving wheel 12 to be lower than that of the left driving wheel 12; and
S10: Controlling the right driving wheel 12 to rotate backwards.

The following is a detailed explanation of the technical solution of the present disclosure, combined with a specific embodiment.

The specifications of the angle sensor are shown in FIG. 12. An effective mechanical angle of the sensor is ±21°, a total of 42°, and the corresponding analog voltage output value is 0.3-4.5V. When it is in a mechanical middle position of 0°, the corresponding analog output value is 2.4V; In this embodiment, Uₐ=U_{f}=1.3V; U_{b}=2.3V; U_{c}=2.5V; U_{d}=U_{g}=3.5V; Uₑ=0.3V; and Uₕ=4.5V.

The angle sensor is applied to the depth recognition of the accelerator pedal 30:

From the specifications of the angle sensor mentioned above, it can be seen that when the mechanical angle changes from −21° to +21°, the output voltage of the sensor corresponds to 0.3-4.5V. According to different mechanical structure designs, the actual mechanical angle range used by the sensor may vary. Here, the design is based on the maximum range, that is, the accelerator pedal 30 is from not being stepped on up to the deepest step, the mechanical angle of the angle sensor increases from −21° to +21°, and the output voltage value increases from 0.3V to 4.5V. Assuming that the user has no steering demand, the driving direction is forward, and the maximum rotational speed of the running motor is 3000 rpm. Therefore, when two motor drivers detect a voltage change in the accelerator pedal 30 sensor, the rotational speed of the driving motor increases from 0 rpm to the maximum rotational speed of 3000 rpm, and the rotational speed is directly proportional to the output voltage value of the accelerator pedal 30. Namely:

N=714*U₂−214.2;
wherein, N is the rotational speed of the motor (unit: rpm); and
U₂ is the output voltage value of the accelerator pedal 30 (unit: V).

The angle sensor is applied to the steering angle recognition of the steering wheel 20.

Due to the left and right rotation directions of the steering wheel 20, when the steering wheel 20 is in the middle position, the angle sensor should be in the initial installation position, meanwhile the detection angle of the angle sensor should be 0°, which also corresponds to the initial position of the steering wheel 20. Different models and requirements may have different extreme mechanical steering angles for the steering wheel 20. Due to the secondary transmission between the steering wheel 20 and the angle sensor in the present disclosure, changing the transmission ratio can change the limit voltage output value of the angle sensor. From the perspective of the sensor, it is explained that the maximum mechanical angle change of the sensor is known to be 42°. In order to meet the requirements of normal driving and zero steering, this angle range needs to be divided for the following purposes:
a). forward, interval A, ±1°, 2.3˜2.5V;
b). left normal turning, interval B1, −1°˜−11°, 1.3˜2.3V;
c). left zero steering turning, interval C1, −11°˜—21°, 0.3˜1.3V;
d). right normal turning, interval B2, +1°˜+11°, 2.5˜3.5V;
e). right zero steering turning, interval C2, +11°˜+21°, 3.5˜4.5V;

Here, taking the forward direction as an example:
a) is used as a steering dead zone to prevent steering from being too sensitive and exceeding user's expectations, and also to reduce deviations between different machines. When in this area, the rotational speed of the left and right wheels are the same, and the directions are determined by the gear switch.
b) is used for left turning, where the rotational directions of the two wheels are the same, however, as the angle of the steering wheel 20 turning to the left increases, the rotational speed of the left wheel will decrease until the steering reaches the boundary between b) and c), and the rotational speed of the left wheel drops to 0 rpm.
c) is used for left zero steering, where the rotational directions of the two wheels are inconsistent, and as the angle of the steering wheel 20 turning to the left increases, the rotational speed of the left wheel will increase until the steering reaches its limit, reaching a negative direction of 3000 rpm, thus achieving complete left zero steering.
d) is consistent with b) in mechanism, where the rotational directions of the two wheels are the same, however, as the angle of the steering wheel 20 turning to the right increases, the rotational speed of the right wheel will decrease until the steering reaches the boundary between d) and e), and the rotational speed of the right wheel drops to 0 rpm.
e) is consistent with c) in mechanism, where the rotational directions of the two wheels are inconsistent, and as the angle of the steering wheel 20 turning to the right increases, the rotational speed of the right wheel will increase until the steering reaches its limit, reaching a negative direction of 3000 rpm, thus achieving complete right zero steering.

Taking a forward gear as an example, a calculation method for running speed in each area is as follows:
here, N_{L} and N_{R} are the rotational speeds of the left and right motors (unit: rpm);
U₁ is the output voltage value of the steering wheel 20 during steering (unit: V);
U₂ is the output voltage value of the accelerator pedal 30 (unit: V);
(1). Forward, U₁∈(2.3, 2.5);

N_{L}=N_{R}=714*U₂−214.2;
(2). Left normal turning, U₁∈(1.3, 2.3);

N_{L}=(U₁−1.3)*N_{R};

N_{R}=714*U₂−214.2;
(3). Left zero steering turning, U₁∈(0.3, 1.3);

N_{L}=−(1.3−U₁)*N_{R};

N_{R}=714*U₂−214.2;
(4). Right normal turning, U₁∈(2.5, 3.5);

N_{L}=714*U₂−214.2;

N_{R}=(3.5−U₁)*N_{L};
(5). Right zero steering turning, U₁∈(3.5, 4.5);

N_{L}=714*U₂−214.2;

N_{R}=−(U₁−3.5)*N_{L}.

In summary, the present disclosure utilizes at least one angle sensor in the vehicle control system to generate an actual position signal indicating the position status of the steering wheel 20, rather than an inferred or expected position of the steering wheel 20, thus effectively improving response speed and response accuracy; the present disclosure utilizes a steering input device (such as the steering wheel 20) to input the operator's operating intention, and detects the actual position of the steering input device through an angle sensor to generate a signal, this signal is processed by the control module 60 to control one or more drivable structures of the vehicle, enabling the driving motor to achieve forward and reverse rotation of the left and right wheels via the gearbox, the universal wheels 11 change the turning angle with the control of the rotational speeds and steering for the left and right rear wheels during steering; the present disclosure avoids the problem of excessive sensitivity of sensor potential changes caused by slight rotation of the steering wheel 20 and some idle stroke on the transmission structure through deceleration transmission, ensuring smooth and stable machine operation during zero steering.

The above embodiments only exemplify the principle and efficacy of the present disclosure, and are not intended to limit the present disclosure. Anyone familiar with this technology may modify or change the above embodiments without violating the scope of the present disclosure. Therefore, all equivalent modifications or changes made by those with ordinary knowledge in the art without departing from the present disclosure shall still be covered by the claims of the present disclosure.

What is claimed is:

1. A garden tool, comprising:
a chassis, which is installed with a universal wheel and at least two driving wheels, one of the universal wheel and the driving wheel being located at a front portion of the chassis and the other at a rear portion of the chassis;
a steering wheel, which is rotatably connected to the chassis;
a first angle sensor, to which the steering wheel is connected through transmission via a deceleration transmission mechanism; and
a control module, to which the first angle sensor is electrically connected, and the control module being respectively electrically connected to driving elements of the two driving wheels, wherein
the control module is configured to:
control the two driving wheels to rotate at equal speeds when a rotational angle of the first angle sensor is within a first preset interval,
control the two driving wheels to rotate at different speeds in a same direction when the rotational angle of the first angle sensor is within a second preset interval, and
control the two driving wheels to rotate in reverse directions when the rotational angle of the first angle sensor is within a third preset interval,
wherein, the second preset interval is distributed at two ends of the first preset interval, and the third preset interval is distributed at two ends of a union of the first preset interval and the second preset interval.

2. The garden tool of claim 1, wherein the deceleration transmission mechanism comprises:
a first transmission shaft, which is fixedly connected to the steering wheel and rotatably connected to a steering wheel bracket provided on the garden tool;
a second transmission shaft, which is rotatably connected to the chassis of the garden tool, wherein a first end of the second transmission shaft is connected to the first transmission shaft via a universal joint in a synchronously rotating manner, and a second end of the second transmission shaft is provided with a first gear;
a second gear, which is rotatably connected to the chassis of the garden tool and is meshed with the first gear, a diameter of the second gear being greater than that of the first gear; and
a swing arm, a first end of the swing arm being connected to the first angle sensor, and a second end of the swing arm being connected to the second gear.

3. The garden tool of claim 1, wherein,
the second preset interval includes a first sub interval and a second sub interval provided at two ends of the first preset interval, respectively;
when the rotational angle of the first angle sensor is within the first sub interval, the control module is configured to control a rotational speed of the driving wheel on a left side to be lower than that of the driving wheel on a right side; and
when the rotational angle of the first angle sensor is within the second sub interval, the control module is configured to control the rotational speed of the driving wheel on the right side to be lower than that of the driving wheel on the left side.

4. The garden tool of claim 3, wherein,
the third preset interval includes a third sub interval and a fourth sub interval, the third sub interval and the fourth sub interval are provided at two ends of the union of the first preset interval and the second preset interval, respectively;
when the rotational angle of the first angle sensor is within the third sub interval, the control module is configured to control the driving wheel on the left side to rotate in an opposite direction; and
when the rotational angle of the first angle sensor is within the fourth sub interval, the control module is configured to control the driving wheel on the right side to rotate in an opposite direction.

5. The garden tool of claim 1, wherein,
the first preset interval is [−1°, +1°].

6. The garden tool of claim 3, wherein,
the second preset interval is [−11°,−1°)∪(+1°,+11°],
wherein the first sub interval is [−11°, −1°), and the second sub interval is (+1°, +11°].

7. The garden tool of claim 4, wherein,
the third preset interval is [−21°,−11°)∪(+11°,+21°],
wherein the third sub interval is [−21°, −11°), and the fourth sub interval is (+11°, +21°].

8. The garden tool of claim 4, wherein the garden tool further comprises a control device, the control device comprising:
an accelerator pedal; and
a second angle sensor, wherein the accelerator pedal is connected to the second angle sensor through transmission via a linkage mechanism, and the second angle sensor is electrically connected to the control module, and
wherein the control module is configured to control a rotational speed of the driving wheel to increase when a rotational angle of the second angle sensor increases.

9. The garden tool of claim 8, wherein,
when the rotational angle of the first angle sensor is within the first preset interval, the rotational speed NL of the driving wheel on the left side and the rotational speed NR of the driving wheel on the right side meet the following requirements:
N_{L}=N_{R}=(Nₘₐₓ/(Uₘₐₓ−Uₘᵢₙ))*(U₂−Uₘᵢₙ);
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, and U₂ represents a real-time output voltage of the second angle sensor; and
wherein an output voltage of the second angle sensor increases with an increase of the rotational angle of the second angle sensor.

10. The garden tool of claim 8, wherein,
when the rotational angle of the first angle sensor is within the first sub interval, the rotational speed N_{L} of the driving wheel on the left side and the rotational speed N_{R} of the driving wheel on the right side meet the following requirements:
N_{R}=(Nₘₐₓ/(Uₘₐₓ−Uₘᵢₙ))*(U₂−Uₘᵢₙ);
N_{L}=((U₁−Uₐ)/(U_{b}−Uₐ))*N_{R};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, Uₐ and U_{b} respectively represent a minimum output voltage and a maximum output voltage of the first angle sensor when the rotational angle of the first angle sensor is within the first sub interval, and U₁ represents a real-time output voltage of the first angle sensor; and
wherein the real-time output voltage U₁ of the first angle sensor increases with an increase of the rotational angle of the first angle sensor, and the real-time output voltage U₂ of the second angle sensor increases with an increase of the rotational angle of the second angle sensor.

11. The garden tool of claim 8, wherein,
when the rotational angle of the first angle sensor is within the second sub interval, the rotational speed N_{L} of the driving wheel on the left side and the rotational speed N_{R} of the driving wheel on the right side meet the following requirements:
N_{L}=(Nₘₐₓ/(Uₘₐₓ−Uₘᵢₙ))*(U₂−Uₘᵢₙ);
N_{R}=((U_{d}−U₁)/(U_{d}−U_{c}))*N_{L};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, U_{c} and U_{d} respectively represent a minimum output voltage and a maximum output voltage of the first angle sensor when the rotational angle of the first angle sensor is within the second sub interval, and U₁ represents a real-time output voltage of the first angle sensor; and
wherein the real-time output voltage U₁ of the first angle sensor increases with an increase of the rotational angle of the first angle sensor, and the real-time output voltage U₂ of the second angle sensor increases with an increase of the rotational angle of the second angle sensor.

12. The garden tool of claim 8, wherein,
when the rotational angle of the first angle sensor is within the third sub interval, the rotational speed N_{L} of the driving wheel on the left side and the rotational speed N_{R} of the driving wheel on the right side meet the following requirements:
N_{R}=(Nₘₐₓ/(Uₘₐₓ−Uₘᵢₙ))*(U₂−Uₘᵢₙ);
N_{L}=−((U_{f}−U₁)/(U_{f}−Uₑ))*N_{R};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, Uₑ and U_{f} respectively represent a minimum output voltage and a maximum output voltage of the first angle sensor when the rotational angle of the first angle sensor is within the third sub interval, and U₁ represents a real-time output voltage of the first angle sensor; and
wherein the real-time output voltage U₁ of the first angle sensor increases with an increase of the rotational angle of the first angle sensor, and the real-time output voltage U₂ of the second angle sensor increases with an increase of the rotational angle of the second angle sensor.

13. The garden tool of claim 8, wherein,
when the rotational angle of the first angle sensor is within the fourth sub interval, the rotational speed N_{L} of the driving wheel on the left side and the rotational speed N_{R} of the driving wheel on the right side meet the following requirements:
N_{L}=(Nₘₐₓ/(Uₘₐₓ−Uₘᵢₙ))*(U₂−Uₘᵢₙ);
N_{R}=−((U₁−U_{g})/(Uₕ−U_{g}))*N_{L};
wherein, Nₘₐₓ represents a maximum rotational speed of the driving wheel, Uₘₐₓ represents a maximum output voltage of the second angle sensor, Uₘᵢₙ represents a minimum output voltage of the second angle sensor, U₂ represents a real-time output voltage of the second angle sensor, U_{g} and Uₕ respectively represent a minimum output voltage and a maximum output voltage of the first angle sensor when the rotational angle of the first angle sensor is within the fourth sub interval, and U₁ represents a real-time output voltage of the first angle sensor; and
wherein the real-time output voltage U₁ of the first angle sensor increases with an increase of the rotational angle of the first angle sensor, and the real-time output voltage U₂ of the second angle sensor increases with an increase of the rotational angle of the second angle sensor.

14. A method for control a garden tool, wherein, the garden tool comprises a first angle sensor configured to identify a rotation of a steering wheel, the first angle sensor being electrically connected to a control module, the control module being respectively electrically connected to a left driving wheel and a right driving wheel, the method comprises:
obtaining a detection signal of the first angle sensor; and
controlling rotational speeds of the left driving wheel and the right driving wheel according to the detection signal, comprising:
controlling the left driving wheel and the right driving wheel to rotate at equal speeds when a left or right rotational angle of the steering wheel is less than or equal to a first preset value;
controlling the rotational speed of the left driving wheel to be lower than that of the right driving wheel when the steering wheel is turning to the left and the rotational angle is larger than the first preset value and less than or equal to a second preset value;
controlling the left driving wheel to rotate backwards when the steering wheel is turning to the left and the rotational angle is larger than the second preset value;
controlling the rotational speed of the right driving wheel to be lower than that of the left driving wheel when the steering wheel is turning to the right and the rotational angle is larger than the first preset value and less than or equal to the second preset value; and
controlling the right driving wheel to rotate backwards when the steering wheel is turning to the right and the rotational angle is larger than the second preset value.

15. The method of claim 14, wherein,
when a left or right rotational angle of the steering wheel is less than or equal to the first preset value, the left driving wheel and the right driving wheel rotate at equal speeds in a same direction;
when the left or right rotational angle of the steering wheel is larger than the first preset value and less than or equal to the second preset value, the left driving wheel and the right driving wheel rotate at different speeds in the same direction; and
when the left or right rotational angle of the steering wheel is larger than the second preset value, the left driving wheel and the right driving wheel rotate at equal speeds in reverse directions.

16. The method of claim 14, wherein,
when a left or right rotational angle of the steering wheel is less than or equal to the first preset value, a rotational angle of the first angle sensor is within a first preset interval;
when the left or right rotational angle of the steering wheel is larger than the first preset value and less than or equal to the second preset value, the rotational angle of the first angle sensor is within a second preset interval; and
when the left or right rotational angle of the steering wheel is larger than the second preset value, the rotational angle of the first angle sensor is within a third preset interval.

17. The method of claim 16, wherein,
the first preset interval is [−1°, +1°].

18. The method of claim 16, wherein,
the second preset interval is [−11°,−1°)∪(+1°,+11°].

19. The method of claim 16, wherein,
the third preset interval is [−21°,−11°)∪(+11°,+21°].

20. The method of claim 14, wherein, the garden tool further comprises:
an accelerator pedal; and
a second angle sensor, wherein the accelerator pedal is connected to the second angle sensor through transmission via a linkage mechanism, and the second angle sensor is electrically connected to the control module, and
wherein the control module is configured to control a rotational speed of the left driving wheel and the right driving wheel to increase when a rotational angle of the second angle sensor increases.
